(19) United States
(12) Patent Application Publication
(10) Pub. No.: US 2015/0160918 A1
(43) Pub. Date: Jun. 11, 2015

(54) Terminal And Reading Method Based On The Terminal

(71) Applicant: TENCENT TECHNOLOGY (SHENZHEN) COMPANY LIMITED, Shenzhen City (CN)

(72) Inventors: Liang ZENG, Shenzhen City (CN); Ming HE, Shenzhen City (CN); Lei CHEN, Shenzhen City (CN)

(21) Appl. No.: 14/623,672

(22) Filed: Feb. 17, 2015

Related U.S. Application Data
(63) Continuation of application No. PCT/CN2013/081932, filed on Aug. 21, 2013.

(30) Foreign Application Priority Data
Aug. 24, 2012 (CN) 201210305162.7

(51) Int. Cl. G06F 3/16; G06F 3/0481

(52) U.S. Cl. CPC G06F 3/167; G06F 3/04817

(57) ABSTRACT

A reading method based on terminal includes a terminal having a touch screen. The reading method includes detecting a touching operation on the touch screen to determine a display object corresponding to the touching operation. Text data corresponding to the display object is extracted and converted data into voice data. The voice data is played. A corresponding terminal is also provided.

### CROSS-REFERENCE TO RELATED APPLICATIONS

This application is a continuation of International Application No. PCT/CN2013/081932 filed on Aug. 21, 2013. This application claims the benefit and priority of Chinese Application No. 201210305162.7, filed Aug. 24, 2012. The entire disclosures of each of the above applications are incorporated herein by reference.

### FIELD

The present disclosure relates to a reading method based on the terminal.

### BACKGROUND

This section provides background information related to the present disclosure which is not necessarily prior art.

With the development of technology, a variety of electronic terminals such as mobile phones, panel personal computers, etc. are widely used and have become an important tool in people's daily life and work. With the increasing popularity of the Internet, users are accustomed to having a variety of terminals to browse news, find information, read e-books, etc. However, for visually impaired people, there are still many difficulties in using a browser of a terminal to browse webpages or read e-books, etc. according to an existing reading method based on terminal.

### SUMMARY

This section provides a general summary of the disclosure, and is not a comprehensive disclosure of its full scope or all of its features.

Overcoming the shortcomings of the existing browser reading technology and provide a new reading method based on the terminal will make it possible for visually impaired people to read audibly.

The present disclosure is directed to various embodiments.

The present disclosure provides a reading method based on a terminal. The terminal includes a touch screen. The reading method includes detecting a touching operation on the touch screen to determine a display object corresponding to the touching operation. The method also includes extracting text data corresponding to the display object, converting the extracted text data into voice data, and playing the voice data.

The present disclosure also provides a terminal including a touch screen. The terminal further includes: a detection module configured to detect a touching operation on the touch screen to determine a display object corresponding to the touching operation. A text data extraction module is configured to extract text data corresponding to the display object. A conversion module is configured to convert the extracted text data into voice data. A playing module is configured to play the voice data.

The present disclosure also provides a computer-readable storage medium including a set of instructions for performing reading. The set of instructions directs at least one processor to perform acts of determining a display object corresponding to an operation on a terminal device, obtaining voice data corresponding to the display object, and playing the voice data.

In the reading method based on terminal and the corresponding terminal of the present disclosure, a touching operation on the touch screen of the terminal can be detected to determine a display object. Corresponding text data can be generated, and then the generated text data can be converted into voice data for being played. This allows visually impaired users to read audibly. This can broaden and simplify the capabilities of the application and it is convenient to use.

The above description is only an overview of the technical solution of the present disclosure, in order to better understand the technical solution of the present disclosure and implement the technical solution according to contents of the specification, and in order to make the above and other objects, features and advantages of the present disclosure clearer, the present disclosure will be described in further detail hereinafter with reference to embodiment and accompanying drawings.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart of a reading method based on terminal according to various embodiments of the present disclosure;

FIG. 2 is a flowchart of a block S2 according to various embodiments of the present disclosure;

FIG. 3 is a flowchart of a block S2 according to various embodiments of the present disclosure;

FIG. 4 is a diagram of a terminal having a touch screen according to various embodiments of the present disclosure;

FIG. 5 is a diagram of a text data extraction module according to various embodiments of the present disclosure; and

FIG. 6 is a diagram of a text data extraction module according to various embodiments of the present disclosure.

Corresponding reference numerals indicate corresponding parts throughout the several views of the drawings.

### DETAILED DESCRIPTION

Example embodiments will now be described more fully with reference to the accompanying drawings.

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

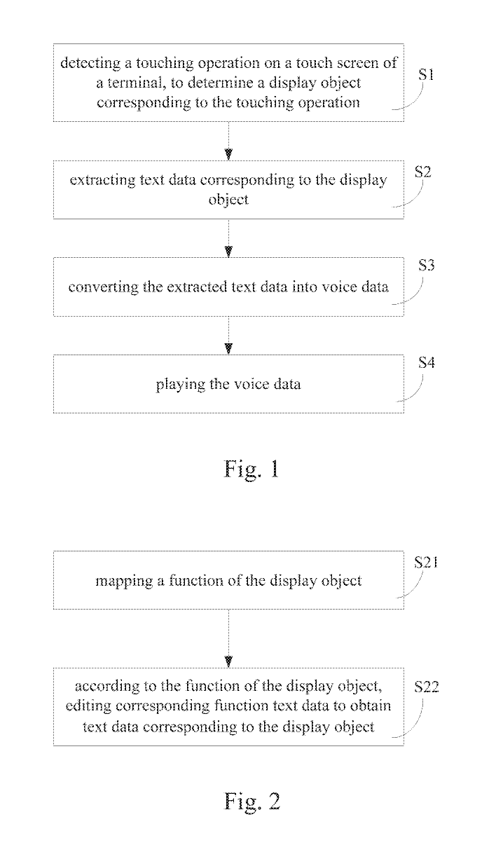

FIG. 1 is a flowchart of a reading method based on a terminal according to various embodiments. The terminal can be an electronic terminal which has a touch screen, for example, currently popular smartphones (such as the iPhone) or panel personal computers (such as the iPad), and so on. A user can touch the touch screen of the terminal so as to perform various corresponding operations. The reading method based on the terminal according to various embodiments can be applied in situations of using a browser of the terminal for browsing or using reading software of the terminal to read an e-book, etc. The reading method based on the terminal will be introduced in the following by taking using the browser of the terminal for browsing as one non-limiting example.

As shown in FIG. 1, the reading method based on terminal according to various embodiments includes:

Block S1: detecting a touching operation on a touch screen of a terminal, to determine a display object corresponding to the touching operation. Generally, the touch screen of the terminal can display a plurality of display objects. These display objects can mainly be divided into two types, one type is function operation icon and another type is specific text. Taking an open browser on the terminal as an example, when the browser is displayed, both function operation icons and specific text will be displayed. The function operation icons of the browser can correspond to operations of the browser itself; such as, switching windows, adding bookmarks, opening corresponding webpages from the start page, etc. The specific text of the browser is usually specific text in webpages; for example, specific news, novels, etc.

Block S2: extracting text data corresponding to the display object. FIG. 2 is a flowchart of block S2 according to various embodiments. As shown in FIG. 2, when the display object corresponding to the detected touching operation in block S1 is a function operation icon, then block S2 specifically includes:

Block S21: mapping a function of the display object; and

Block S22: according to the function of the display object, editing corresponding function text data to obtain text data corresponding to the display object.

When the touched display object in the touching operation is a function operation icon, such as, a function operation icon “refresh webpage” of the browser, the terminal will determine function of the function operation icon and then edit corresponding text data. That is, edit text data corresponds to “refresh webpage” which is taken as a display object.

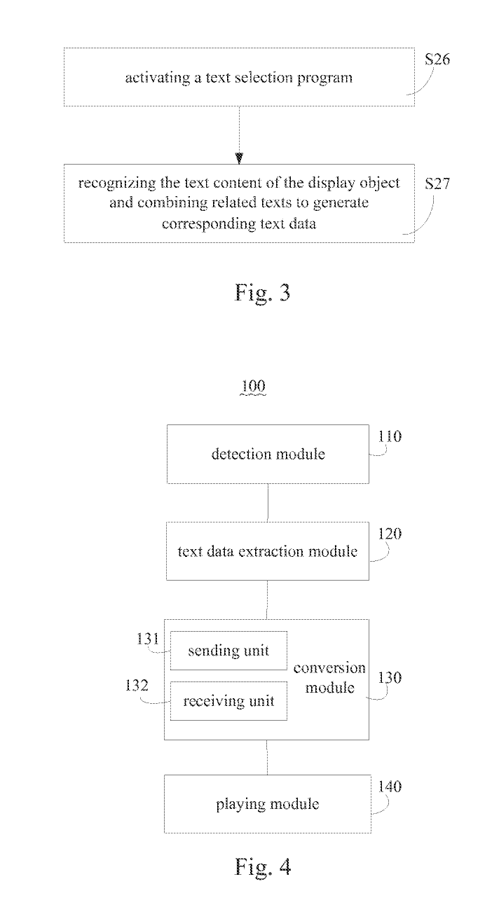

FIG. 3 is a flowchart of block S2 according to various embodiments. As shown in FIG. 3, when the display object corresponding to the detected touching operation in block S1 is specific text, then block S2 specifically includes:

Block S26: activating a text selection program; and

Block S27: recognizing the text content of the display object and combining related texts to generate corresponding text data.

When the touched display object in the touching operation is specific content, for example, content of news or content of a novel, the text selection program of the terminal can be used to recognize corresponding text content thereby generating corresponding text data.

Block S3: converting the extracted text data into voice data. In various embodiments, the terminal can send the extracted text data to a server side, the server side recognizes the text data, thereby generating corresponding voice data; then, the terminal receives the voice data returned from the server side after the server side recognizes the text data. One skilled in the art will understand that, in the present disclosure, the extracted text data can be converted into voice data directly in the terminal.

Block S4: playing the voice data.

The present disclosure also provides a corresponding terminal. FIG. 4 is a diagram of a terminal having a touch screen according to various embodiments. As shown in FIG. 4, the terminal 100 of one embodiment of the present disclosure comprises a detection module 110, a text data extraction module 120, a conversion module 130, and a playing module 140.

The detection module 110 is configured to detect a touching operation on a touch screen of the terminal 100, to determine a display object corresponding to the touching operation. The text data extraction module 120 is configured to extract text data corresponding to the display object. The conversion module 130 is configured to convert the extracted text data into voice data. The playing module 140 is configured to play the voice data. The display objects on the touch screen can be divided into two types: one type is function operation icon and another type is specific text.

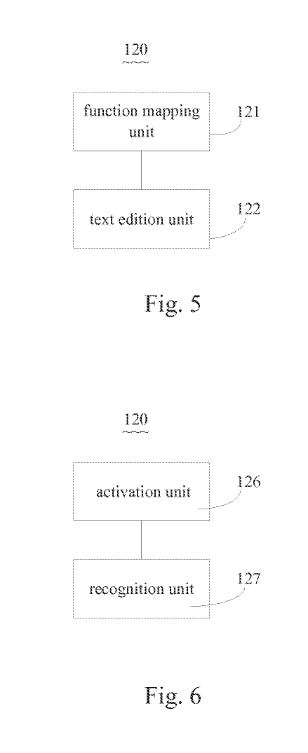

FIG. 5 is a diagram of the text data extraction module 120 according to various embodiments of the present disclosure. As shown in FIG. 5, when the display object corresponding to the detected touching operation is a function operation icon, the text data extraction module 120 includes a function mapping unit 121 and a text edition unit 122. The function mapping unit 121 is configured to map a function of the display object. The text edition unit 122 is configured to, according to the function of the display object, edit corresponding function text data to obtain text data corresponding to the display object.

FIG. 6 is a diagram of the text data extraction module 120 according to another embodiment of the present disclosure. As shown in FIG. 6, when the display object corresponding to the detected touching operation is specific text, the text data extraction module 120 includes an activation unit 126 and a recognition unit 127. The activation unit 126 is configured to activate a text selection program. The recognition unit 127 is configured to recognize the text content of the display object and combine related texts to generate corresponding text data.

Further, as shown in FIG. 4, in various embodiments, the conversion module 130 can include a sending unit 131 and a receiving unit 132. The sending unit 131 is configured to send the extracted text data to a server side so that the server side recognizes the text data and generates corresponding voice data. The receiving unit 132 is configured to receive the voice data returned from the server side after the server side recognizes the text data. Terminal 100 can send the extracted text data to the server side and the server side can convert the extracted text data into the voice data. One skilled in the art will recognize that the extracted text data can be converted into voice data directly in the terminal 100.

In the reading method based on terminal and the corresponding terminal of the present disclosure, a touching operation on the touch screen of the terminal can be detected to determine a display object, corresponding text data can be generated, and then the generated text date can be converted into voice data for being played, thereby allowing visually impaired people to read audibly, this can broaden and simplify the capabilities of the application and it is convenient to use.

The methods, modules, units and terminals described herein may be implemented by hardware, machine-readable instructions or a combination of hardware and machine-readable instructions. Machine-readable instructions used in the examples disclosed herein may be stored in a storage medium readable by multiple processors, such as a hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD, specific-purpose computers and so on.

A machine-readable storage medium is also provided to store instructions to cause a machine to execute a process as described according to examples herein. In one example, there is provided a system or apparatus having a storage medium that stores machine-readable program codes for implementing functions of any of the above examples and that may cause the system or the apparatus (or CPU or MPU) to read and execute the program codes stored in the storage medium.

In this situation, the program codes read from the storage medium may implement any one of the above examples.

The storage medium for storing the program codes may include a floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What have been described and illustrated herein are examples along with some variations. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A reading method based on terminal, the terminal comprising a touch screen, wherein the reading method comprises:
detecting a touching operation on the touch screen, to determine a display object corresponding to the touching operation;
extracting text data corresponding to the display object;
converting the extracted text data into voice data;
playing the voice data.

2. The method of claim 1, wherein the display object is a function operation icon.

3. The method of claim 2, wherein the step of extracting text data corresponding to the display object comprises:
mapping a function of the display object;
according to the function of the display object, editing corresponding function text data to obtain the text data corresponding to the display object.

4. The method of claim 1, wherein the display object is text content.

5. The method of claim 4, wherein the step of extracting text data corresponding to the display object comprises:
activating a text selection program;
recognizing the text content of the display object and combining related texts to generate the corresponding text data.

6. The method of claim 4, wherein the step of converting the text data into voice data comprises:
sending the extracted text data to a server side so that the server side recognize the text data and generates corresponding voice data;
receiving the voice data returned from the server side after the server side recognizes the text data.

7. A terminal comprising a touch screen, wherein the terminal further comprises:
a detection module configured to detect a touching operation on the touch screen to determine a display object corresponding to the touching operation;
a text data extraction module configured to extract text data corresponding to the display object;
a conversion module configured to convert the extracted text data into voice data; and
a playing module configured to play the voice data.

8. The terminal of claim 7, wherein the display object is a function operation icon.

9. The terminal of claim 8, wherein the text data extraction module comprises:
a function mapping unit configured to map a function of the display object;
a text edition unit configured to, according to the function of the display object, edit corresponding function text data to obtain the text data corresponding to the display object.

10. The terminal of claim 7, wherein the display object is text content.

11. The terminal of claim 10, wherein the text data extraction module comprises:
an activation unit configured to activate a text selection program;
a recognition unit configured to recognize the text content of the display object and combine related texts to generate the corresponding text data.

12. The terminal of claim 7, wherein the conversion module comprises:
a sending unit configured to send the extracted text data to a server side so that the server side recognizes the text data and generates corresponding voice data;
a receiving unit configured to receive the voice data returned from the server side after the server side recognizes the text data.

13. A computer-readable storage medium comprising a set of instructions for performing reading, the set of instructions to direct at least one processor to perform acts of:
determining a display object corresponding to an operation on a terminal device;
obtaining voice data corresponding to the display object; and
playing the voice data.

14. The computer-readable storage medium of claim 13, wherein the obtaining voice data corresponding to the display object comprises:
obtaining text data corresponding to the display object;
converting the obtained text data into the voice data.

15. The computer-readable storage medium of claim 13, wherein the obtaining text data corresponding to the display object comprises:
determining whether the display object is a function operation icon or text content;
when the display object is a function operation icon, the obtaining text data corresponding to the display object further comprises: mapping a function of the display object; and according to the function of the display object, editing function text data corresponding to the display object to obtain the text data corresponding to the display object;
when the display object is text content, the obtaining text data corresponding to the display object further comprises: activating a text selection program; and
recognizing the text content of the display object and combining related texts to generate the corresponding text data.
